(19) United States
(12) Patent Application Publication
(10) Pub. No.: US 2016/0261216 A1
(43) Pub. Date: Sep. 8, 2016

(54) System and Method for Controlling the Operation of an Electric Motor of a Compressor

(71) Applicant: WHIRLPOOL S.A., São Paulo, SP (BR)

(72) Inventors: Roberto ANDRICH, Joinville, SC, (BR); Dietmar Erich Bemhard LILIE, Joinville, SC, (BR)

(21) Appl. No.: 15/025,130

(22) PCT Filed: Jul. 29, 2014
(86) PCT No.: PCT/BR2014/000257

§ 371 Date: Mar. 25, 2016

(30) Foreign Application Priority Data
Sep. 25, 2013 (BR) BR102013024565 8

(51) Int. Cl. H02P 21/18; F04B 49/20; F04B 35/04

(52) U.S. Cl. CPC H02P 21/18; F04B 35/04; F04B 49/20

(57) ABSTRACT

The present invention refers to a system for controlling the operation of an electric motor of a compressor, comprising at least one predictive speed control loop (4) constituted by at least one speed controller (41), at least one processing core (42) and at least one signal delay circuit (43), wherein an output signal of said predictive loop (4) is added to the output signal of the outer speed control loop (1). It also relates to a method for controlling the operation of an electric motor of a compressor, comprising at least one step for discretizing a first refrigeration cycle (CR1) into a plurality of virtual sectors (J) in accordance with a previously known sampling rate, at least one step for determining the speed correction factor in each virtual sector (J) of the first refrigeration cycle (CR1), at least one step for discretizing a subsequent refrigeration cycle (CR1) into a plurality of virtual sectors (J) in accordance with a sampling rate used in the discretization of the first refrigeration cycle (CR1), and at least one step for applying each speed correction factor of the first refrigeration cycle (CR1) in the equivalent virtual sectors (SVN) of the subsequent refrigeration cycle (CRN).

### FIELD OF THE INVENTION

The present invention refers to a system for controlling the operation of an electric motor of a compressor and a method for controlling the operation of an electric motor of a compressor, more particularly an adaptive system and method for (preferably reciprocating) compressors subjected to at least two different levels of working pressure as it occurs in compressors used, for example, in double-evaporation systems.

Generally, the present invention intends to decrease the electric motor speed during alteration of compressor working pressure.

### BACKGROUND OF THE INVENTION

As it is known by those skilled in the art compressors, and particularly reciprocating compressors, comprise equipments capable of altering a working fluid pressure by controllably altering the volume of a compression chamber, which is usually defined by a cylindrical chamber which receives a working fluid and a movable piston. Hence, a compressor chamber volume is alternately (reduced and increased) altered in function of the movable piston displacement in its interior. The inlet and working fluid removal are orderly administered through suction valves and discharge valves, which have their states alternately shifted.

In conventional reciprocating compressors, alternative movement of the movable piston comes from a rotation driving force in rotary movement and, especially, comes from an electric motor provided with a rotating shaft. In conventional embodiments, said rotary movement of the electric motor shaft is converted to an alternative movement through an eccentric shaft cooperating with a linear rod, which is connected to an alternative piston. This means that the rotary movement of the motor shaft is converted to an alternative (back-and-forth) movement imposed to the alternative piston.

Conventionally, it is observed that electric parameters and mechanical parameters of the electric motors undergo different interferences and oscillations along compression cycles.

For example, it is known that the electric current of an electric motor tends to increase as the compression cylinder pressure increases. This ratio between electric current of the electric motor during pressure increase occurs because of the extra effort made by the electric motor (consuming more electric current) when the piston reaches, under high pressure, its maximum positive displacement prior to the opening of the discharge valve in the interior of the compression cylinder, generating the highest compression pressure.

It is also known that the electric motor speed tends to decrease as the compression cylinder pressure increases. This ratio between electric motor speed, during pressure increase, also stems from the higher effort made by the electric motor (wherein a higher hindrance to maintenance of its nominal speed occurs) when the alternative piston, under high pressure, reaches its maximum positive displacement inside the compression cylinder, generating the highest compression pressure.

In this context, it is also known by those skilled in the art that reciprocating compressors can be used in systems where working fluid reaches different pressure levels. An example of this system type refers to refrigeration systems comprising independent evaporators operating at different temperature ranges, and, consequently, under different pressure ranges.

An embodiment of this refrigeration system type is disclosed in the International Patent Application PCT/BR2011/000120, which teaches a double-evaporation refrigeration system wherein each evaporator is directly connected to a reciprocating compressor suction inlet. Consequently, said reciprocating compressor comprises a double-suction reciprocating compressor having a single compression chamber. Particular, in this case, selection of one from two working fluids is carried out via valves located in the compressor itself.

It is also worth mentioning that the present state of the art provides double-evaporation refrigeration systems, where multiple different evaporators (with different working pressures) are connected to an outer selecting valve, which has a single outlet connected to a sole reciprocating compressor suction inlet. An example of this arrangement is disclosed in U.S. Pat. No. 5,531,078.

In both examples, one same compression chamber is, at different times, subjected to different pressure levels. Consequently, compression mechanism and its driving force (electric motor) are subjected to two different effort levels.

As formerly mentioned, by simply altering the pressure during a compression cycle (with a single working fluid) it is already sufficient to impair the electric motor speed. In the case of double-evaporation compressors (as described either in International Patent Application PCT/BR2011/000120 or in U.S. Pat. No. 5,531,078), speed reduction effects of an electric motor are still more serious.

This stems from the fact that an electric motor tends to present a substantial decrease in speed during the entire higher pressure working fluid cycle. It is clear that this speed drop impairs the reciprocating compressor performance because this represents a reduction in refrigeration capacity for the higher pressure evaporator and, consequently, there is a reduction in the performance of a refrigeration system as a whole.

However, it occurs that traditional systems and methods for operation control of reciprocating compressor electric motors are integrally reactive, that is, they predict an increase in control action (normally, voltage feed to the electric motor for correction of speed reduction) only after a substantial speed drop is preliminarily detected.

Usually, this implies in the design of a speed controller having a very rapid response, which commonly results in a substantial consumption of the entire system. Optionally, this may also imply in a design of a speed controller having a very slow response, which usually does not satisfactorily eliminates the variation of the electric motor speed of the reciprocating compressor.

In view of the above-mentioned drawbacks and due to the need to eliminate them, the present invention is developed.

### OBJECTS OF THE INVENTION

By this way, one of the objects of the present invention is to provide a control system and method for operation of compressor electric motor capable of predictably increasing electric motor voltage, that is, prior to the initial moment of its speed drop.

Another object of the present invention is to provide said control system and method for operation of compressor electric motor, which can eliminate, or at least diminishing to acceptable values, the variation of the electric motor speed when the compressor compression mechanism is subjected to variation between two possible different working pressures in double-evaporation refrigeration system.

### SUMMARY OF THE INVENTION

All these objects are entirely achieved by a control system for operation of compressor electric motor and control method for operation of compressor electric motor, wherein both are objects of the present invention.

Generally speaking, the control system for operation of compressor electric motor comprises at least an electric motor control subsystem formed by an outer speed control loop constituted by at least one speed controller, at least one inner control loop, at least one block for measuring electric parameters of the electric motor and at least one predictive speed control comprising at least one speed controller, at least one processing core and at least a signal delay circuit, wherein the output signal of said predictive loop is added to the output signal of the outer control speed loop.

In accordance with the present invention, said speed controller permits to generate speed correction signal of the compressor electric motor.

With regard to the processing core, same is responsible for virtual sectorization, according to previously determined sampling rates of the compressor electric motor operation cycles, and it is responsible for measuring average speed of the compressor electric motor of each formerly defined virtual sector.

In turn, the signal delay circuit is responsible for the output signal of the predictive loop to be added to the output signal of the speed control outer loop.

Optionally, and still in accordance with the present invention, said predictive loop further comprises a second processing core for measuring speed peak of the compressor electric motor of each virtual sector previously defined by the processing core.

The control method for operation of compressor electric motor, wherein said compressor is capable of acting in a double-evaporation refrigeration system having at least two different working pressure levels alternatively selected in cycles, comprises at least a step of discretizing a first refrigeration cycle into a plurality of virtual sectors according to a previously known sampling rate; at least a step for determining the speed correction factor in each virtual sector of the first refrigeration cycle; at least a step of discretizing a subsequent refrigeration cycle in a plurality of virtual sectors in accordance with a sampling rate used in the discretization of the first refrigeration cycle; and at least a step for applying each speed correction factor of the first refrigeration cycle in equivalent virtual sectors of a subsequent refrigeration cycle.

Preferably each of the virtual sectors comprises a mechanical turn of electric motor inside a compressor compression cycle, or further, any submultiple of each of the compressor compression cycles.

Its further preferred that all steps are repeated during a compressor operation along multiple refrigeration cycles and, optionally, application of each speed correction factor of the first refrigeration cycle in the equivalent virtual sectors of the subsequent refrigeration cycle only occurs during the higher pressure level.

### BRIEF DESCRIPTION OF THE DRAWINGS

The present invention will be explained in detail below, based on the following figures, wherein:

FIG. 1 illustrates a graph referring to a speed variation of an electric motor by means of an alteration between the different pressure levels when a traditional speed controller type is used.

FIG. 2 illustrates a block diagram of a conventional control system for operation of reciprocating compressor electric motor, which is responsible for graph of FIG. 1;

FIG. 3 illustrates a first block diagram of a control system for operation of reciprocating compressor electric motor of the present invention;

FIGS. 4A, 4B and 4C illustrate graphs referring to speed variation of an electric motor by means of an alteration between two different pressure levels when using a control system for operation of reciprocating compressor electric motor depicted in FIG. 3;

FIG. 5 illustrates a second block diagram of the control system for operation of reciprocating compressor electric motor of the present invention; and

FIG. 6 illustrates a graph referring to speed variation of an electric motor by means of alteration between two different pressure levels when using a control system for operation of reciprocating compressor electric motor depicted in FIG. 5.

### DETAILED DESCRIPTION OF THE INVENTION

### Concerning the Present Method

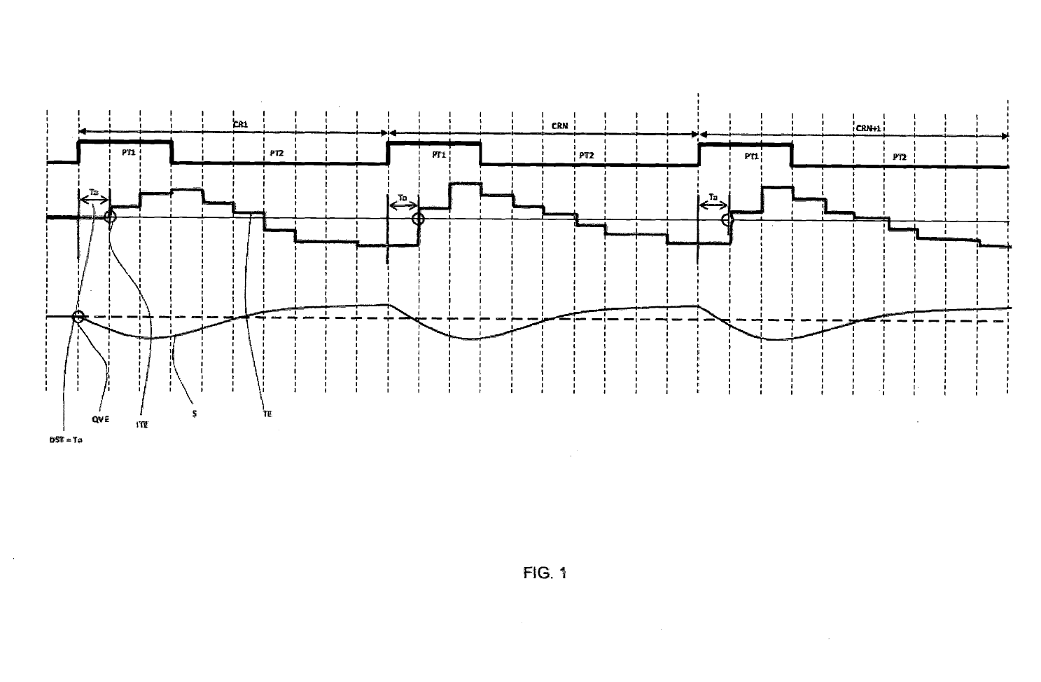

FIG. 1 schematically illustrates a relational graph between speed S and signal TE proportional to an effective voltage of a reciprocating compressor electric motor used in a double-evaporation refrigeration system, that its, a refrigeration system which provides the reciprocating compressor with at least two different working pressure levels PT1 and PT2. As already known by those skilled in the art, there is an intrinsic ratio between these two parameters (motor speed and motor voltage) in reciprocating compressors.

With regard to FIG. 1, two working pressure levels PT1 and PT 2 are further constantly repeated along refrigeration cycles CR. Nevertheless, it should be pointed out that such alternation between the two working pressure levels PT1 and PT2 in double-evaporation refrigeration system is not always defined in refrigeration cycles CR having constant duration. As it is known by those skilled in the art, an alteration between the two working pressure levels PT1 and PT2 is effected by a valve arrangement, which can be disposed at the reciprocating compressor itself (as described in International Patent Application PCT/BR2011/000120), or anywhere in the refrigeration system (as described in U.S. Pat. No. 5,531,078.

Anyhow and as formerly described, it is further observed that the electric motor speed S undergoes two variations along refrigeration cycles CR and especially during alternation between two working pressure levels PT1 and PT2.

It is clear that the speed S variation of the electric motor is harmful to the efficiency of the reciprocating compressor compression.

In order to solve this problem, it is common that reciprocating compressor electric motors are controlled by speed loops especially dedicated to controlling electric motor operation. Generally, such speed loops intend to supply effective voltage by varying the reference TE in electric motors as soon as speed S drops are detected.

As it is known by those skilled in the art, the present control systems for operation of electric motor act according to an operation logic, that is, an operation method. In accordance with the present control methods, the reference of effective voltage TE in the electric motor is only increased after a speed S drop has been clearly detected.

This means that the electric motor receives an increment of effective voltage TE after speed S drop occurs, wherein in FIG. 1 the beginning of a drop of speed S is indicated by reference QVE.

Once the increment in voltage of reference of voltage TE is made in a passive form, it is verified that the response to this stimulus (increase in speed S) occurs in delay. Consequently, it is possible to contact a time mismatch DST between the time at which the decrease QVE of speed S occurs and the time at which the increase of reference TE of effective voltage (the time of increase is indicated in FIG. 1 through reference ITE). This time mismatch is given by a sampling period used by the speed loop.

In the FIG. 1, the sampling period is equal to a mechanical turn of the compressor electric motor, it is then verified that an entire turn of the compressor electric motor before the voltage reference TE is incremented. Clearly the actuation speed of this increment can be increased, that is, increasing the sampling period, but even so there would still exist a longer or shorter time mismatch DST since this increment always occurs in a reactive form, that is, always after a sampling period.

Concerning the Present System

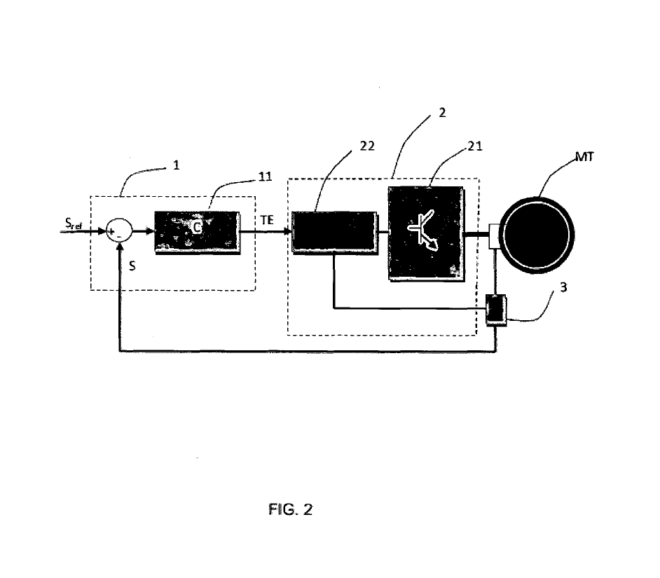

The system responsible for the above-mentioned logic is schematically illustrated in FIG. 2.

The control system for operation of reciprocating compressor electric motor illustrated in FIG. 2 comprises an arrangement already known by those skilled in the art, that is, as it can noted the system essentially comprises an outer speed control loop 1, an inner control loop 2, at least one block 3 for measuring electric parameters and, clearly, one electric motor MT.

As known by those skilled in the art, the outer speed control loop 1 comprises at least one speed controller 11, which to all purposes refers to an electronic circuit that controls the amplitude of increments of reference TE of the effective voltage S of the electric motor. Generally, the speed controller 11 is usually of the integral proportional type and usually has an updating frequency equal to, or higher than, the mechanical (speed) frequency of the electric motor MT.

In FIG. 2, for example, the speed controller 11 updates its output signal TE proportionally to an effective voltage applied to the motor, at each mechanical turn of the electric motor MT. This type of controller always acts in reactive form, that is, it is required that an error variation in its input occurs such that the output is then corrected.

The inner control loop 2 (whose output is not a voltage but rather a value proportional to voltage), which is also known by those skilled in the art, comprises at least one potency modulus 21, which, for all purposes, refers to a frequency inverter which is capable of electrically feeding an electric motor. The inner control loop 2 is also formed by a control block 22 that can be of the following types: six-step, vector control, direct torque control torque or any other traditional technique for electric motor control.

Furthermore, and also in accordance with the knowledge of those skilled in the art, block 3 for measuring electric and/or mechanical parameters may generally comprise a circuit for measuring voltages of currents, of positions and of nominal speed of a reciprocating compressor motor. This type of circuit is very common and may include already known different configurations.

The electric motor MT comprises a conventional electric motor, which can be alternating current or direct current type.

It should be pointed out that the real and functional specifications of the outer speed control loop 1, the inner control loop 2 and block 3 for measuring electric parameters will depend on the electric motor MT type being used in reciprocating compressor.

Anyway, the system illustrated in FIG. 2 is responsible for operation control of a reciprocating compressor electric motor, wherein the ratio of speed S and reference TE of effective voltage is illustrated in FIG. 1.

In this context, it can be noted that the presently existing huge problem resides in the existence of the mentioned and illustrated time mismatch DST and a consequent variation in motor speed, and the main object of the present invention is to eliminate or reduce to acceptable levels said time mismatch DST during operation of a reciprocating compressor electric motor such that electric motor speed has a minimized variation during alternation between two working pressure levels PT1 and PT2.

Concerning the New System

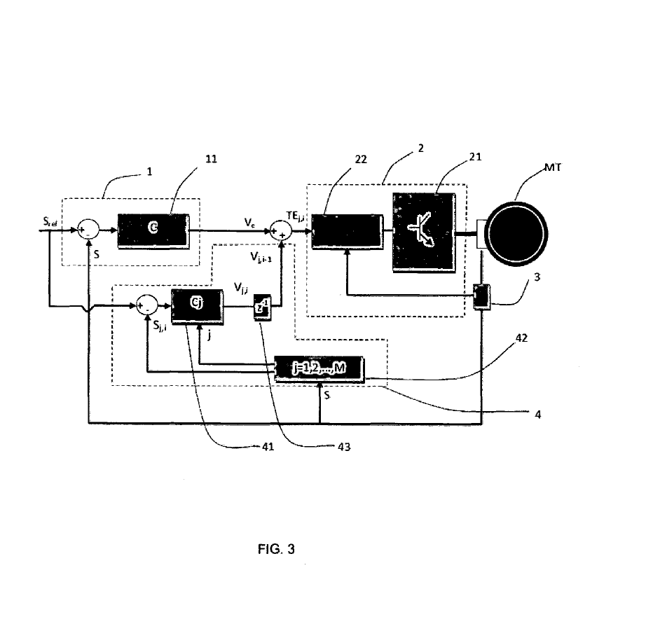

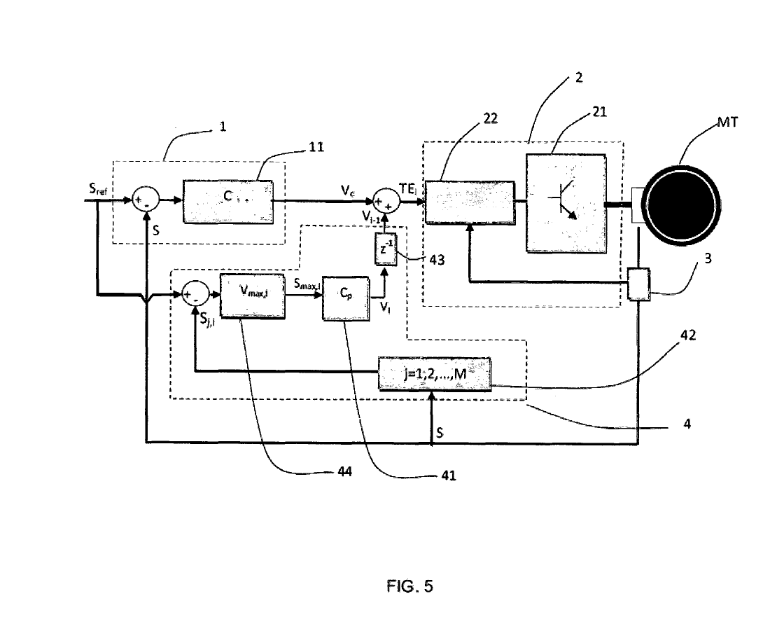

Hence, FIGS. 3 and 5 illustrate block diagrams of preferred embodiments of the control system for operation of reciprocating compressor electric motor of the present invention.

These figures then illustrate a system basically comprising an outer speed control loop 1, an inner control loop 2, a block 3 for measuring electric and/or mechanical parameters of the electric motor MT, and a predictive speed control loop 4.

Therefore, it can be verified that a large difference between the system illustrated in FIG. 3 and the conventional system illustrated in FIG. 2 resides in the addition of said predictive speed control loop 4, whose output signal is added to the output signal of the outer speed control loop 1, that is, the final signal reference TE proportional to effective voltage to be applied to the motor by means of said inner loop 2 will be the sum of the output of the conventional speed controller Vc and the predictive controller ΔV_{j,i-1}.

Generally, said predictive loop 4 of the speed control essentially comprises a speed controller 41, a processing core 42 and a signal delay circuit 43.

Preferably, and in accordance with the present invention, the processing core 42 comprises a block capable of dividing each refrigeration cycle CR into a sub-cycle number M or virtual sectors J to measure the average speed of each of these sectors.

In general, the processing core 42 is responsible for a virtual sectorization, in accordance with the previously determined sampling rates, of the operation cycles of the reciprocating compressor electric motor MT, in addition to being responsible for measuring the average speed Sⱼ of the reciprocating compressor electric motor MT of each previously defined virtual section J. These two functionalities will be better understood from the description of the control method for operation of compressor electric motor.

Also preferably and yet in accordance with the present invention, the speed controller 41 comprises a set of controllers, preferably of integral proportional type, with one controller for each virtual sector J defined from the processing core 42.

Additionally, it should be pointed out that said speed controller 41 of the predictive loop 4 of the speed control is responsible for generating the speed correction signal of the reciprocating compressor electric motor MT for each virtual sector J, and this functionality is better understood from the description of the control method for operation of compressor electric motor.

Finally, and yet in accordance with the present invention, the signal delay circuit 43 comprises a block to store the correction factors of each virtual sector J of each refrigeration cycle CRᵢ and to apply said correction factors to the next refrigeration cycle CRᵢ₊₁.

In brief, it can be affirmed that the signal delay circuit 43 is responsible for the output signal delay of the predictive loop 4 to be added to the output signal of the outer speed control loop 1.

Based on the explanation above, it should be emphasized that the output signal of a predictive speed control loop 4 comprises a signal of the type equivalent to the output signal of the outer speed control loop 1, that is, it comprises a signal proportional to the effective voltage to be applied to the motor.

Hence, and in the case of the present system, the output signal Vc of the outer speed control loop 1 is incremented to the output signal of the predictive speed control loop 4, that is, the signal ΔV_{j,i-1}, and such sum of signals is sent to the inner control loop 2, which, as known by those skilled in the art, effectively supplies electric feed to the electric motor MT based on said used control strategies, which as formerly said can be any of the control strategies existing for driving motors, such as, for example, six-step, vector, torque direct control types, etc.

It should be pointed out that the actuation of the predictive speed control loop 4 is, for all purposes, delayed, that is, the signal increment provided by the predictive speed control loop 4 during the cycle CRᵢ occurs only in the next refrigeration cycle CRᵢ₊₁. Equally, this aspect will be better understood from the description of the control method for operation of compressor electric motor.

Optionally, and as illustrated in FIG. 5, the control system for operation of reciprocating compressor electric motor may also include a second processing core 44, which is responsible for measuring the maximal speed reduction ΔSₘₐₓ of the reciprocating compressor electric motor compared to reference S_{REF}, among all virtual sectors J in each refrigeration cycle CR previously defined by the processing core 42 of the predictive speed control loop 4.

This optional embodiment of the control system for operation of reciprocating compressor electric motor, even with the addition of said second processing core 44, is a simplification of the system because after all said second processing core 44 aims at searching for the maximum speed reduction S within each refrigeration cycle, wherein its input ΔSₘₐₓ is used in the input of the speed controller 41, wherein this can be reduced to a controller preferably of the proportional and integral type which will generate a single speed correction factor to be summed to the outer speed control loop 1 during the application of the most elevated working pressure PT1. Attention should be drawn to the fact that block 41 does not consist of a set of controllers as illustrated in FIG. 3, but rather of a single controller.

Concerning the New Method of the New System

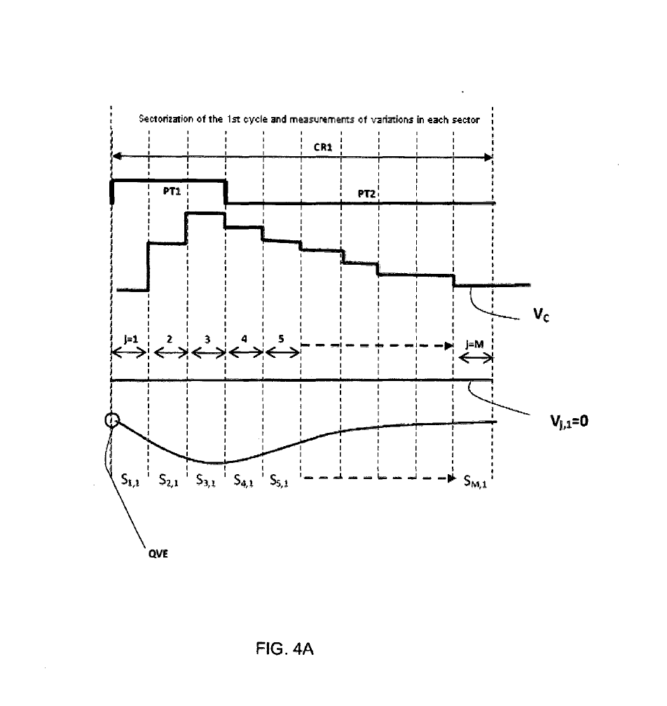

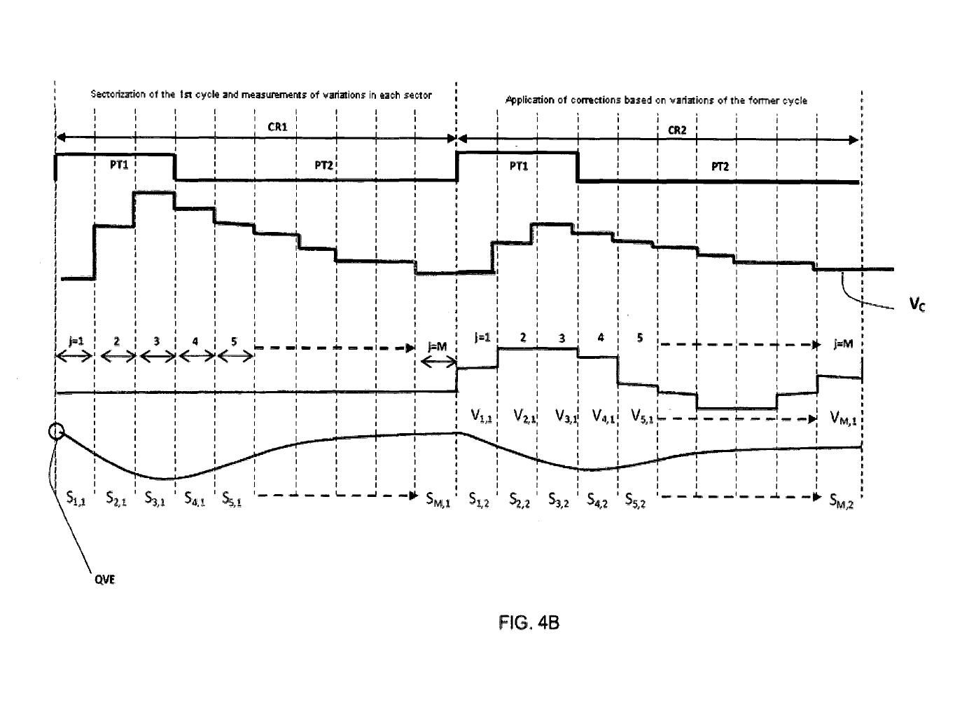

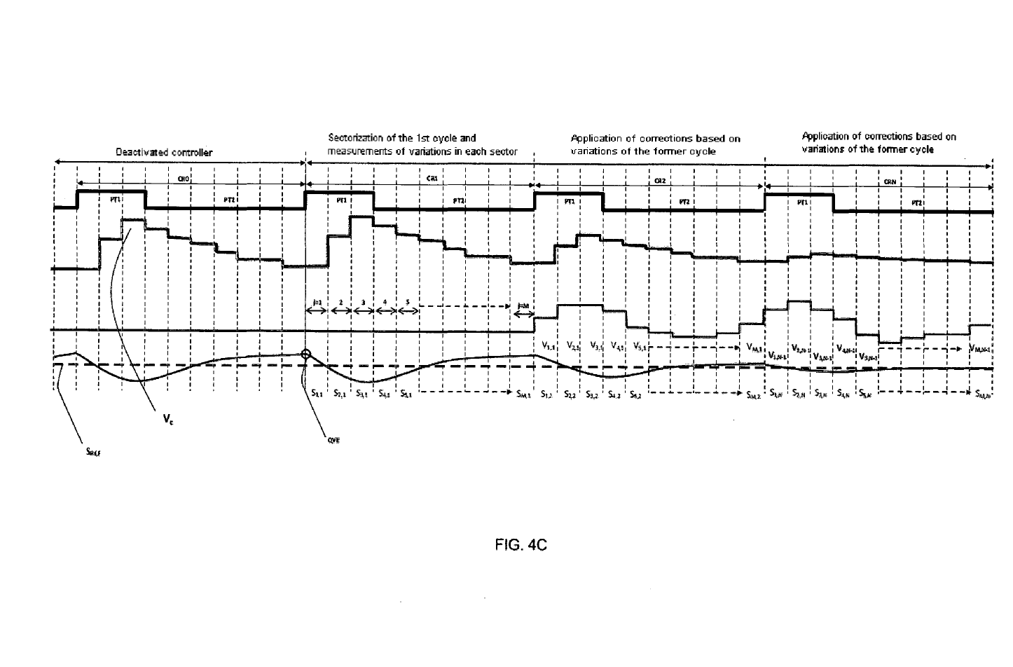

As illustrated in FIGS. 4A, 4B and 4C, it is verified that the control method for operation of reciprocating compressor electric motor (designed by the control system for operation of reciprocating compressor electric motor) is initiated in the refrigeration cycle CR1 and effectively starts acting only in the refrigeration cycle CR2. Note that in the preceding cycle the activation of the method, that is, activation of the predictive controller, the refrigeration cycle CR0 operates only with the conventional speed loop, as had already been shown in FIG. 1.

The proposed method, that is, a predictive controller, although activated in cycle CR1, starts acting only in cycle CR2 due to the fact that said method preliminarily needs to check certain control parameters of the electric motor MT when this refrigeration cycle CR1 is under operation. Thus, said method then begins acting in refrigeration cycles CR2, 3, N, always using the history of variations read in the preceding cycles so as to gradually copy the variation profile of the load and to suitably correct the controller output in order to eliminate the speed variation S.

Anyway, said control method for operation of reciprocating compressor electric motor can be described in detail by means of the following steps:

Step 1: Discretizing a first refrigeration cycle CR1 into a plurality of virtual sectors J=1, 2, 3, . . . , M in accordance with a previously known sampling rate;

Step 2: Determining the speed error in each virtual sector J of the refrigeration cycle for application in the composed controller 41 shown in FIG. 3;

Step 3: Obtaining correction factors ΔV_{J,I} of each sector J of cycle CRᵢ for each application in cycle CRᵢ₊₁;

Step 4: Applying said correction factors ΔV_{J,I} of each sector J of cycle CRᵢ, in cycle CRᵢ₊₁ and returning to step 3 to repeat the process now in cycle CRᵢ₊₁ for application in the next cycle CRᵢ₊₂.

FIG. 4A illustrates step 1, in which a first refrigeration cycle CR1 is discretized into a plurality of virtual sectors J in accordance with a previously known sampling rate. This discretization can be carried out through processing core 42 of the predictive speed control loop 4. FIG. 4A exemplifies the first refrigeration cycle CR1 which is discretized into ten virtual sectors J=1, 2, 3, . . . , 10.

Further, from FIG. 4A, it can be verified that each of ten virtual sectors J has a different value of speed Sⱼ, consequently, it is possible to determine the speed correction factor in each virtual sector J of the first refrigeration cycle CR1, as shown in step 3.

This speed correction factor can be determined by several ways which are already known by those skilled in the art.

Preferably, this calculation can be made by comparing a real speed value with a reference speed value S_{REF}, as described in step 2, wherein the difference between these values is used as parameter to dimension said speed correction factor, which in this case is value ΔV_{J,1} in the output of block 41 which will be summed to the output of the conventional controller Vc of block 11 to obtain an effective reference voltage TE to be supplied to the electric motor MT. Thus, as the difference between the real speed and the reference speed increases, higher will be the speed correction factor and, consequently, higher will be the amplitude of the effective reference voltage TE to be supplied to the electric motor MT.

The higher the discretizations sampling rate of step 1, the higher the accuracy of the speed correction factors of step 3.

Further, it is worth to mention that in step 3 the speed correction factor is only calculated with no need to be applied during the first refrigeration cycle CR1.

Nevertheless, and in accordance with the now detailed method, a delay in the first refrigeration cycle CR1 is totally expected to occur. Nevertheless, steps 3 and 4 as well as the systematic repetition thereof allows for, from a subsequent refrigeration cycle CRN, this delay to be overcome.

Thus, and as illustrated in FIG. 4B, a subsequent refrigeration cycle CR2 is discretized into a plurality of virtual sector J according to a sample rate used in the discretization of the first refrigeration cycle CR1. In the case illustrated in this figure, a subsequent refrigeration cycle CR2 is also discretized into ten virtual sectors J.

Once the speed correction factor of each of the ten virtual sectors J is already known, as defined in step 3, it will be sufficient to apply this same speed correction factor in the equivalent virtual sectors J=1, 2, 3, . . . , 10 of the subsequent refrigeration cycle CR2, as depicted in FIG. 4B.

The application itself of these speed correction factors (determined in the first refrigeration cycle CR1) in the subsequent refrigeration cycle CR2 is effected by the speed controller 41 of the predictive speed control loop 4.

Clearly, it can be considered that such multiple speed correction factors, each specifically suitable for one of the virtual sector J, are applied in a delayed form (after all, the speed correction factors of a first refrigeration cycle are only used in a subsequent refrigeration cycle), and this delay, so to speak, is controlled by a signal delay circuit 43 of the predictive speed control loop 4.

In FIG. 4C, in which all cycles are illustrated at once, steps 2, 3, and 4 are repeated in a third refrigeration cycle CRN.

In this case, it should be emphasized that the second refrigeration cycle, in addition to being applied to the speed correction factors “delayed” from the first refrigeration cycles, steps 1 and 2 of the presently disclosed method are also being simultaneously carried out. This allows for the third refrigeration cycle to receive the speed correction factors from the second refrigeration cycle.

Thus, the speed correction factor used in the third refrigeration cycle is more aligned with the real needs of the speed control of the reciprocating compressor motor.

Consequently, and as illustrated in FIG. 4C, the presently proposed method, provided that it is continuously carried out in all refrigeration cycles, can maintain the real speed value S extremely close to the ideal speed value S_{REF}.

From FIG. 4C, it is important to observe that the cycle-to-cycle tendency is the output of the conventional controller to tend to a constant reference voltage value of the motor whereas the output of the predictive controller makes up for the input of the most elevated pressure level and the motor speed tends to the reference value S_{REF}.

Further, it should be noted that preferably the control of the speed correction factors can be of the integral proportional type, whose speed correction factors are calculated from the reference speed S_{REF} and from the average speed S_{J,j} computed within each of the sectors j, wherein the subscript “i” represents the present cycle of actuation of the controller, and the output of each of the controllers will be correction factors (DV_{1,j}=DV_{1,i-1}+K*(S_{REF}−S_{1,i}); DV_{2,i}=DV_{2,i-1}+K*(S_{REF}−S_{2,i}); . . . ; DV_{M,i}=DV_{N,i-1}+K*(S_{REF}−S_{M,i})) to be summed to the output of the speed controller 11 of the outer speed control 1 in the next refrigeration cycle (TE_{1,i+1}=V_{c}+DV_{1,i}; TE_{2,i+1}=V_{c}+DV_{2,i}; . . . ; TE_{M,i+1}=V_{c}+DV_{M,i}).

In brief, it can be then affirmed that in accordance with the control method for operation of reciprocating compressor electric motor carried out by the control system for operation of reciprocating compressor electric motor, the basic difference between the results of the present invention and the results of the state-of-the-art method systems resides in the fact that now a solution is presented, which copies cycle-to-cycle the optimized format of the load of the preceding cycle so as to predictively eliminate the rotation oscillation of the compressor electric motor due to the repetitive characteristic of the load.

Optionally, and based on the optional alteration of the predictive speed control loop 4 of the control system for operation of reciprocating compressor electric motor (including the second processing core 44, as illustrated in FIG. 5), the speed correction factor can be only applied in the moments where the most elevated working pressure level PT1 enters.

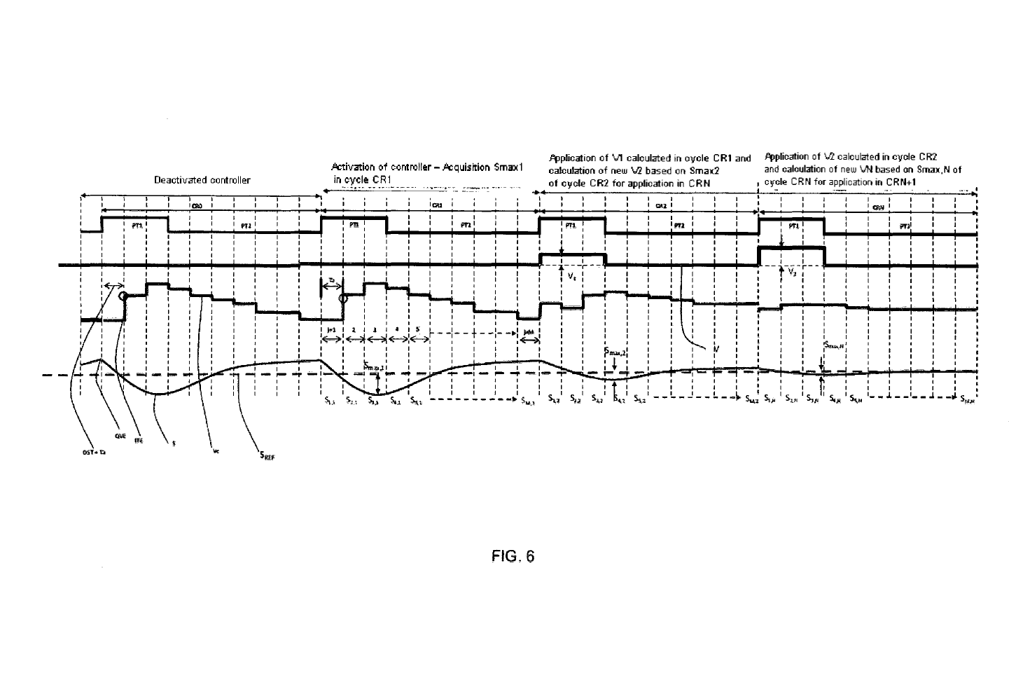

In this case, and as illustrated in FIG. 6, said speed correction factor is always updated to be summed to the output of the conventional controller in the next cycle. Thus, also as in the case of FIG. 4C, the cycle-to-cycle tendency is the output of the conventional controller to tend to a constant reference voltage value of the motor whereas the output of the predictive controller makes up for the input of the most elevated pressure level and the motor speed tends to the reference value.

In view of the embodiments of the invention described and illustrated above, it should be clear that the scope of the invention is only limited by the contents of the appended claims, including possible equivalents.

1. System for controlling the operation of an electric motor of a compressor, comprising:
at least one subsystem of electric motor control formed by an outer speed control loop (1) comprised by at least one speed controller (11), at least one inner control loop (2) and at least one block (3) for measuring electric and/or mechanical parameters of the electric motor (MT);
said control system for operation of compressor electric motor being CHARACTERIZED in that it further comprises:
at least one predictive speed control loop (4) integrated by least one speed controller (11), at least one processing core (42) and at least one signal delay circuit (43); and
the output signal of said predictive loop (4) is added to the output signal of the outer speed control loop (1).

2. System, in accordance with claim 1, CHARACTERIZED in that said speed controller (41) generates the speed correction signal of the compressor electric motor (MT).

3. System, in accordance with claim 1, CHARACTERIZED in that the processing core (42) is responsible for virtually sectorizing the operation cycles of the compressor electric motor (MT) and is responsible for measuring the average speed of the compressor electric motor (MT) of each previously defined virtual sector.

4. System, in accordance with claim 1, CHARACTERIZED in that a signal delay circuit (43) is responsible for delaying the output signal of the predictive loop (4) to be added to the output signal of the outer speed control loop (1).

5. System, in accordance with claim 1, CHARACTERIZED in that said predictive loop (4) further comprises a second processing core (44).

6. System, in accordance with claim 5, CHARACTERIZED in that said second processing core (44) is responsible for measuring a maximal speed reduction ΔS_{MAX} of the compressor electric motor (MT), among all virtual sectors previously defined by processing core (42).

7. Method for controlling the operation of an electric motor of a compressor, wherein said compressor can act in a double-evaporation refrigeration system with at least two different working pressure levels (PT1, PT2), which are alternatively selected in cycles (CR1, CRN);
said control method for operation of compressor electric motor being CHARACTERIZED in that it comprises:
at least one step of discretizing a refrigeration cycle (CR₁) into a plurality of virtual sectors (J=1, 2, 3, . . . , M) in accordance with a sampling rate;
at least one step for determining a speed correction factor in each virtual sector (J) of the refrigeration cycle (CR₁);
at least one step for discretizing a subsequent refrigeration cycle (CR_{N}) into a plurality of virtual sectors (J) in accordance with a sampling rate used for discretization of the refrigeration cycle (CR₁); and
at least one step for applying each speed correction factor of the refrigeration cycle (CR₁) in the equivalent virtual sectors (j=1, 2, 3, . . . , M) of the subsequent refrigeration cycle (CR_{N}).

8. Method, in accordance with claim 7, CHARACTERIZED in that each of the virtual sectors (J) comprises a mechanical turn of the electric motor (MT) within a compressor compression cycle.

9. Method, in accordance with claim 7, CHARACTERIZED in that each of the virtual sectors (J) comprises any submultiple of each of the compressor compression cycles.

10. Method, in accordance with claim 7, CHARACTERIZED in that the steps of claim 7 are repeated during compression operation along the multiple refrigeration cycles.

11. Method, in accordance with claim 7, CHARACTERIZED in that a maximum speed reduction ΔS_{MAX} is measured in the virtual sectors j=1, 2, 3, . . . , M of the refrigeration cycle CR1 to calculate a single speed correction factor ΔV to be applied in the next cycle CR_{N}.

12. Method, in accordance with claim 11, CHARACTERIZED in that the correction factor ΔV, calculated from the refrigeration cycle CR₁, which is used in the next cycle CR_{N}, can be applied with a time mismatch Δt in relation to the application of working pressure PT1.

13. Method, in accordance with claim 12, CHARACTERIZED in that the time mismatch Δt can be a delay or advance relative to the beginning of the working pressure PT1.
